(19) United States
(12) Patent Application Publication
(10) Pub. No.: US 2023/0237559 A1
(43) Pub. Date: Jul. 27, 2023

(54) ECOMMERCE PURCHASE WITHIN A SHORT-FORM VIDEO ENVIRONMENT

(71) Applicant: Loop Now Technologies, Inc., San Mateo, CA (US)

(72) Inventors: Di Wang, New York, NY (US); Jing Xian Chen, Dublin, CA (US); Yufan Jiang, San Francisco, CA (US); Jerry Ting Kwan Luk, Menlo Park, CA (US); Ziming Zhuang, Palo Alto, CA (US)

(21) Appl. No.: 18/100,627

(22) Filed: Jan. 24, 2023

Related U.S. Application Data
(60) Provisional application No. 63/431,757, filed on Dec. 12, 2022.
(60) Provisional application No. 63/430,372, filed on Dec. 6, 2022.
(60) Provisional application No. 63/424,958, filed on Nov. 14, 2022.
(60) Provisional application No. 63/423,128, filed on Nov. 7, 2022.
(60) Provisional application No. 63/414,604, filed on Oct. 10, 2022.
(60) Provisional application No. 63/413,272, filed on Oct. 5, 2022.
(60) Provisional application No. 63/395,370, filed on Aug. 5, 2022.
(60) Provisional application No. 63/388,270, filed on Jul. 12, 2022.
(60) Provisional application No. 63/351,840, filed on Jun. 14, 2022.
(60) Provisional application No. 63/350,894, filed on Jun. 10, 2022.
(60) Provisional application No. 63/344,064, filed on May 20, 2022.
(60) Provisional application No. 63/332,703, filed on Apr. 20, 2022.
(60) Provisional application No. 63/302,593, filed on Jan. 25, 2022.
(60) Provisional application No. 63/437,397, filed on Jan. 6, 2023.
(60) Provisional application No. 63/438,011, filed on Jan. 10, 2023.

(51) Int. Cl. G06Q 30/0601; H04L 65/1083; G06F 3/04842

(52) U.S. Cl. CPC G06Q 30/0635; H04L 65/1083; G06F 3/04842

(57) ABSTRACT

Techniques for ordering items using ecommerce purchase within a short-form video environment are disclosed. A short-form video from a plurality of short-form videos delivered from a short-form video server is rendered. A product within the video is selected. The selecting is accomplished by clicking on or mousing over an object in the video. The product within the video is added to a virtual purchase cart based on the selecting. Contents of the virtual purchase cart are visible while the video is being viewed. A representation of the virtual purchase cart is displayed, wherein the representation is visible while viewing the short-form video. The virtual purchase cart is checked out. Contents of the virtual purchase cart are purchased. Purchase of the product is finalized upon conclusion of the short-form video. Finalizing purchase is accomplished using a batch order process. Batch order processing occurs upon conclusion of the short-form video.

### RELATED APPLICATIONS

This application claims the benefit of U.S. provisional patent applications “Ecommerce Purchase Within A Short-Form Video Environment” Ser. No. 63/302,593, filed Jan. 25, 2022, “Tokenizing A Manipulated Short-Form Video” Ser. No. 63/332,703, filed Apr. 20, 2022, “Short-Form Videos Usage Within A Frame Widget Retail Environment” Ser. No. 63/344,064, filed May 20, 2022, “Manipulating Video Livestream Background Images” Ser. No. 63/350,894, filed Jun. 10, 2022, “Product Card Ecommerce Purchase Within Short-Form Videos” Ser. No. 63/351,840, filed Jun. 14, 2022, “Search Using Generative Model Synthesized Images” Ser. No. 63/388,270, filed Jul. 12, 2022, “Creating And Populating Related Short-Form Video Segments” Ser. No. 63/395,370, filed Aug. 5, 2022, “Object Highlighting In An Ecommerce Short-Form Video” Ser. No. 63/413,272, filed Oct. 5, 2022, “Dynamic Population Of Contextually Relevant Videos In An Ecommerce Environment” Ser. No. 63/414,604, filed Oct. 10, 2022, “Multi-Hosted Livestream In An Open Web Ecommerce Environment” Ser. No. 63/423,128, filed Nov. 7, 2022, “Cluster-Based Dynamic Content With Multi-Dimensional Vectors” Ser. No. 63/424,958, filed Nov. 14, 2022, “Text-Driven AI-Assisted Short-Form Video Creation In An Ecommerce Environment” Ser. No. 63/430,372, filed Dec. 6, 2022, “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, and “Augmented Performance Replacement In A Short-Form Video” Ser. No. 63/438,011, filed Jan. 10, 2023.

Each of the foregoing applications is hereby incorporated by reference in its entirety.

### FIELD OF ART

This application relates generally to ordering items and more particularly to an ecommerce purchase within a short-form video environment.

### BACKGROUND

With the continued adoption of smartphones, tablets, and portable computers, video is fast becoming the norm for digital communications. Currently, video and streaming feeds can be used for classroom instruction, keeping in touch with friends and family, coordinating business activities, accessing sports highlights, watching movies at home, etc. Fast and ubiquitous home and business internet access through cable, DSL, satellite, and fiber technologies have been critical for this expansion of video consumption. Improved cellular network technology and coverage have been equally important, moving from older 3G/CDMA and GSM networks to 4G/LTE, 5G/OFDM, and beyond. Each time internet speed and bandwidth has improved, devices and technologies have been created to introduce new capabilities. In recent years, these have included services such as on-demand TV, video streaming websites, video steaming “sticks”, and a myriad other video services. All of these technologies have led to a massive increase in video consumption.

Individuals are now able to consume video from almost anywhere on any connected device—at home, in the car, or even walking outside. Especially on mobile devices, social media platforms have become an extremely common use of internet-based video. Accessed through the use of a browser or specialized app that can be downloaded, these platforms include Facebook, TikTok, YouTube, Snapchat, and Instagram among a plethora of other services. While these services vary in their video capabilities, they are generally able to display short video clips, repeating video “loops”, livestreaming, music videos, etc. These videos can last anywhere from a few seconds to an hour or more. Countless hours are spent online watching an endless supply of video from friends, family, social media “influencers”, gamers, favorite sports teams, or from a plethora of other sources.

Traditional businesses have also taken advantage of the trend towards online video. It is commonplace for businesses to host their own tutorials, “vlogs” (video logs), testimonials, product demos, etc. on their websites. Businesses have also adopted webinars and livestreaming events to generate DTC (direct to consumer) as well as B2B (business-to-business) interest in their products and services. Many have contracted with outside advertising firms to develop online video-based advertising campaigns. Another growing use of online video technology is video conference calls where two or more employees can collaborate while out of the office or travelling. Some video calls can host a hundred or more participants and can be used for key business leaders to communicate vision and strategy to their entire corporation. Individuals may also use this technology for remaining in communication with colleagues working from home or even to stay in touch with distant friends and family members.

The rise of technologies and services, which have enabled video, have led to a new level of engagement. While not all of this engagement is productive, users consume vast amounts of video online. As technologies improve and new services are enabled, video consumption is sure to increase in the future.

### SUMMARY

Personal electronic devices such as mobile devices can be used to access information of many types on the Internet. The electronic devices, which can include desktop computers, laptop computers, and personal electronic devices such as tablets, smartphones, and PDAs, are widely used by people who want to observe and interact with content such as product information. The product information can be presented as a short-form video stream. The video streams can include livestreams in which an individual or team of individuals can present thoughts and comments, present goods and services, and so on. The video streams can be used to promote an individual, a cause, a good, or a service, etc.; to present information such as news, sports, government announcements, entertainment, or educational material; and so on. The video streams can supply an advertisement or advertisement stream. A video stream can be viewed on any of a wide range of electronic devices. The video stream can be viewed in a window associated with a video app or player, by using a plugin associated with a web browser window, etc. An originator of a video stream, such as an influencer or other individual, can include in their stream one or more products that have come favorably or unfavorably to the attention of the originator. A viewer can click on a product within the video to purchase the product. A viewer also can click on a product within the video to obtain further information about the product, a good, a service, etc. Selecting the product within the video can add the product to a virtual purchase cart associated with the user. A product that is selected by a viewer can be placed into a virtual purchase cart. The virtual purchase cart can include a virtual shopping cart, virtual shopping bag, and the like. The user can check out using the virtual purchase cart. The checking out can accomplish purchasing the contents of the cart. The purchase of the cart contents can be finalized at the conclusion of the short-form video. The finalized purchasing can be accomplished as a “one click” purchase if a user has preregistered prior to viewing the video stream.

Display is accomplished using a video stream interface that can be executed on an electronic device associated with a user. The video stream, such as a short-form video, livestream video, advertisement video, etc., can include one or more products. The display can show information associated with the products within the video by accessing information from a third-party website. The product information can include text, video, and audio content. The user (e.g., the viewer of the video) can purchase one or more of the products presented within the video. The video that the viewer observes can be delivered from a short-form video server. The contents of the server can be provided by an individual, a team, a stream provider, and so on. The video stream can include a livestream video. The video streams can supply an advertisement or advertisement stream. The video stream is displayed using a video player executing on a device. The video stream can be displayed within a frame, or a window associated with the video player. The displaying the video can be accomplished using an app, a window associated with a web browser, and the like. The video can contain one or more products. The viewer can click on the one or more products within the video to learn more about the products, to purchase the products, etc. A product can be selected by clicking on it, mousing over it, and the like. The selected product can be added to a virtual purchase cart, where the virtual purchase cart can include a virtual shopping cart, a virtual shopping bag, a virtual tote, etc. A representation of the virtual purchase cart can be displayed while the viewer is viewing the short-form video. The virtual purchase cart is checked out upon conclusion of the short-form video.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram of an ecommerce purchase within a short-form video environment.

FIG. 2 is a flow diagram for virtual purchase cart handling.

FIG. 3 shows a system block diagram for an ecommerce purchase within a video.

FIG. 4 illustrates adding an item to a virtual purchase cart.

FIG. 5 shows enabling a virtual purchase cart for purchase.

FIG. 6 illustrates a short-form video and product information on a device.

FIG. 7 is a system block diagram for an add-to-cart operation.

FIG. 8 illustrates product purchase within a short-form video.

FIG. 9 is a system diagram for ordering items.

### DETAILED DESCRIPTION

Techniques for ordering items based on an ecommerce purchase within a short-form video environment are disclosed. The short-form video environment renders a short-form video, where the short-form video is delivered from a server. The short-form video includes products that are shown, promoted, demonstrated, etc. by a person within the video. A viewer of the video can choose to buy one or more of the products shown. The viewer can purchase one or more of the products by selecting desired products within the video. If the viewer has registered prior to viewing the video (i.e., “preregistered”), the purchasing of the items can be based on a “one click” technique. If the viewer has not preregistered, then the viewer goes through a registration or sign-in process for the first purchase, then can purchase additional items by selecting the desired items within the video. The one or more items selected by the viewer are added to a virtual purchase cart. To ensure that the viewer is granted quantity discounts, promotional codes, free shipping, and other “perks”, finalizing purchase of the one or more selected items is accomplished using batch order processing. The batch order processing combines products from a given vendor into one order, applies appropriate discounts and coupons, checks for free shipping, etc. The batch order processing occurs upon conclusion of the short-form video.

The video viewed by the individual can include a video stream video, a livestream video, a short-form video, an advertisement video, etc. A video stream such as the short-form video can be received and viewed using an electronic device such as a desktop computer, a laptop computer, a tablet, a smartphone, a personal digital assistant (PDA), and so on. The video can be viewed using an app such as a video player, a web browser with a video plugin, and so on, loaded on an electronic device. The video stream can be created by one or more individuals, an organization, an enterprise, and the like. The video stream enables an individual, for example, to reach out to their subscribers, followers, fans, like-minded individuals, the curious, and others. The video stream can present a message such as an opinion, an announcement, a product promotion or criticism, etc. The video and products included in the video stream can be rendered to a user by a user interface. Further information about the products can be obtained from a third-party webpage. The products within the video stream can be purchased by selecting the products. The selection of one or more products can be accomplished by tapping, clicking, or mousing over the one or more products. Selected items are added to a virtual purchase cart. The virtual purchase cart can include a virtual shopping cart, virtual shopping bag, virtual tote, etc. By selecting the product, a viewer is presented with product details such as size, color, style, availability, configuration details, shipping and handling costs, and the like. The product details are displayed over a portion of the video while the video continues to play. The viewer can choose a particular version of the product, a size and color, etc., and can purchase the product.

Ecommerce purchasing of items is enabled using a short-form video environment. A short-form video is delivered from a short-form video server. The short-form video is rendered and displayed on an electronic device such as a mobile device. The short-form video shows one or more people and one or more products. A viewer of the short-form video can purchase an item in the video, learn more about the item, and so on by selecting the item. The item is selected by tapping, clicking, mousing over, etc. Information about the product the viewer wishes to purchase is obtained from a website hosted by a third party. The third-party website can include an information source, a search engine, an online retailer, and so on. The third-party website can include product information in the form of images, audio, text, videos, and the like. Information about one or more products is rendered by a video user interface to a user. The video user interface can include a video app, a window associated with a web browser, and the like. The video user interface can be executed on a range of electronic devices such as smartphones, PDAs, tablets, and computers. The product information is rendered and displayed over a portion of the short-form video being viewed by the viewer while the short-form video continues to play. Interfacing with the third-party website can be accomplished using a callback function such as a JavaScript™ callback function. Product information is fetched from a server based on the interfacing between the video user interface and the third party. The video is augmented with further information based on the fetching. The augmenting can include opening a window or a frame, where the window or the frame can appear to be superimposed “on top” of the video stream in which the product appeared. The augmenting enables the user to further view the product, to select the particular product of interest, to configure the product, and so on. The user can then purchase the product. The purchasing of the product is enabled through the video stream interface and is executed on the third-party webpage.

A video stream in which a product is included can include a livestream, a video stream, a short-form video, an advertisement stream, and so on. In the case of a livestream video, the video can be provided by an individual who desires to speak about a product, share an opinion about the product, comment on a news story associated with the product, and so on. The video stream including the product is displayed in a window or frame on a display associated with a device. The window or frame can be associated with an app such as a video app, video player, or web browser. The product rendered within the video can be selected for purchase. Selection of the product can be accomplished by familiar device interactions such as swiping, tapping, or clicking. The selection of the product enables adding of the product to a virtual purchase cart. The selection of the product further enables fetching additional information about the product from a server. The product information can be fetched from a third-party webpage. The product information that is fetched can be based on the type of product such as clothing, cosmetics, computing hardware, fishing tackle, power tools, etc. The product information that is fetched can be rendered within a window or child frame. The product information can be rendered “on top” of the video which contained the product. The product information can be reduced or altered in size prior to rendering on a portion of the device display. The product information can be rendered within a video such as a reduced video. The reduced video can be rendered on top of the video. The reduced video can be rendered initially at a position within the window and can be moved to another position based on an action taken by the user. In embodiments the rendering the video along with a webpage from the website is accomplished without a popup window.

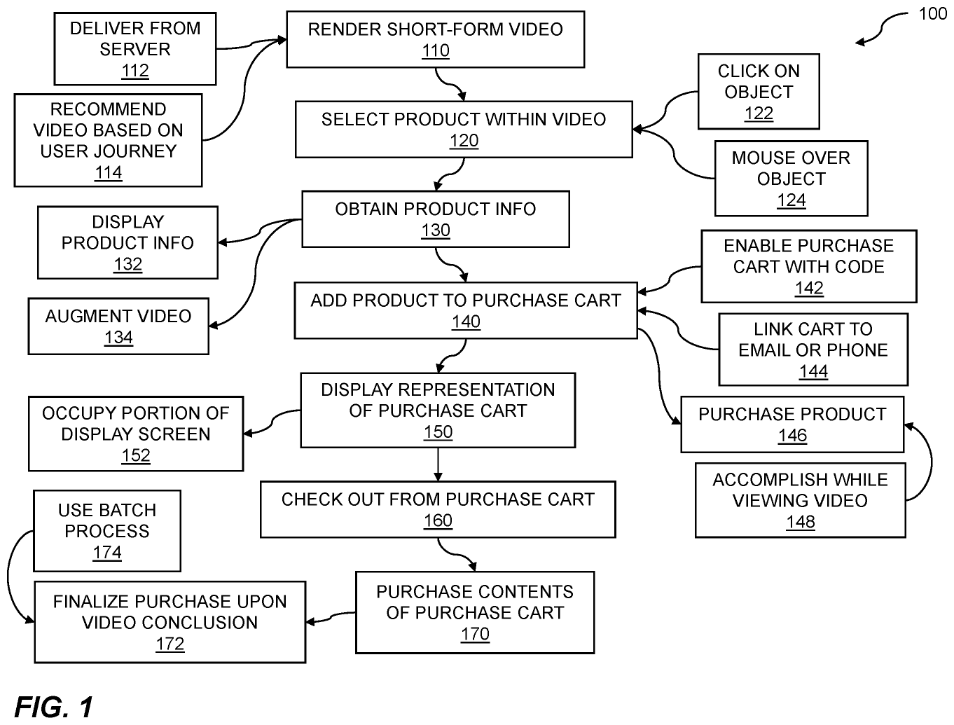

FIG. 1 is a flow diagram of an ecommerce purchase within a short-form video environment. Videos, which can include livestream videos, video streams, short-form videos, advertisement videos, and so on, can include various media and content types. While some videos can include news videos, educational videos, entertainment videos, political message videos, and so on, video stream videos can include live or recorded videos provided by individuals, teams of collaborators, and the like. The livestream videos can be provided by social media influencers, tastemakers, celebrities, and others. Anyone with access to minimal equipment such as a camera, a microphone, and an electronic device, and who has something to say, can provide a video stream to inform, entertain, or inspire others, or to amuse just themselves. The videos can be viewed on an electronic device used by an individual. The viewing can be accomplished by rendering the video within a frame associated with a window. The window can include a window provided by an app, a window associated with a web browser, etc. The video can include one or more products, where the products can be available for purchase. The products can be sold by a vendor, e-tailer, etc. on a third-party website. The products can be selected for purchase, by the person viewing the video, by interacting with the products within the video. The interacting can include clicking, tapping, hovering a cursor, and so on. Information associated with the products selected for purchase can be provided to the person viewing the video. The information can include links to other webpages associated with a website; other websites; content such as text, images, audio, and video; and so on. The information can be fetched from a server, such as a server associated with a vendor. The information that is fetched can be used to augment a video, where the video can include a video about the one or more products. The augmented video can be rendered in a window or frame associated with a video user interface. The user can continue to view the video and can interact with the contents rendered in a frame such as a child frame. The video can be paused and restarted, while the contents in the child frame can be scrolled, clicked, etc. The contents within the child frame can be scrollable in the horizontal orientation, in the vertical orientation, etc.

The flow 100 includes rendering a short-form video 110 from a plurality of short-form videos. The short-form videos can include videos made by a social media influencer, an internet celebrity, a tastemaker, a celebrity, an instructor, an expert, and so on. In embodiments, the short-form videos can include livestream videos. The short-form videos, which can typically run for a duration of 30 seconds to 10 minutes or so, can include one or more products. The products can be promoted, endorsed, critiqued, demonstrated, compared, or otherwise presented within the short-form video. The products within the short-form video can be available for purchase by a viewer of the short-form video. The products can include cosmetics, cookware, tool sets, kits, computers, and so on. In embodiments, the product can include a coupon or a membership. In other embodiments, the product can include a service. In the flow 100, the short-form video is delivered from a short-form video server 112. The short-form video server can include a local server, a shared server, a remote server, a cloud-based server, a distributed server, etc. The server can include a server administrated by a provider of a video, a shared server, and the like. In the flow 100, the short-form video is recommended 114 based on a user journey. In embodiments, the user journey comprises videos watched, internet interactions, or purchase history. The short-form video can also be recommended based on user preferences, user profile, and the like. In a usage example, a user who has purchased products for dogs can be shown short-form videos promoting products for dogs in preference over short-form videos promoting products for cats, parakeets, iguanas, etc. In embodiments, the short-form video comprises an advertisement or advertisement video stream. The advertisement stream can include one or more various services, products, coupons, and so on. The advertisement stream can be provided by a third-party person or company that desires a so-called “product placement”. The product placement can be related to one or more of the short-form videos delivered from the plurality of short-form videos. The product placement can be related to a targeted website or user community. The advertisement can conform to an Interactive Advertising Bureau (IAB) format. A variety of sizes are included in IAB formats, such as for a smartphone banner, a mobile phone interstitial, and the like. As described later, purchasing of products or services placed in the advertisement can be completed in situ, that is, completely within the short-form video framework and without having to perform a website redirection, reloading, or linking out. The advertisement can be served in different IAB formats to match different device options. Thus, the advertisement can be used across the open web and various website publishers, which can enable effective ecommerce beyond just a specific merchant's or brand's website.

The flow 100 includes selecting a product 120 within the short-form video. As the short-form video is playing, the viewer can observe one or more products within the video. The user can select a product for purchase as the product that interests the viewer is presented in the video. The product can be selected by interacting with the product within the video. In the flow 100, the selecting of the product is accomplished by clicking 122 on an object in the video. The clicking can be accomplished by clicking a mouse button, tapping a trackpad, and so on. In the flow 100, the selecting of the product is accomplished by mousing over 124 an object in the short-form video for a specified duration. The mousing over can include using a mouse or a trackpad to move a cursor over the product within the video. The specified duration can include a few seconds. The specified duration can be set by the user.

The flow 100 further includes obtaining information 130 on the product from a website hosted by a third party. The obtaining information can include harvesting or “scrubbing” information from one or more pages associated with the website hosted by the third party. In some embodiments, the information can be obtained by a direct product feed from a merchant. The information can include one or more of videos, images, audio files, text, links to further webpages, etc. The flow 100 further includes displaying 132 the information on the product while the short-form video is being viewed. The displaying can be accomplished on the screen associated with the device with which the viewer is observing the short-form video. The displaying the information on the product can occur while a virtual purchase cart is visible (described below). The flow 100 includes augmenting 134 the short-form video with the information on the product. The augmenting can be accomplished using the same window or frame with which the user is viewing the short-form video. The augmenting can provide an additional incentive for the viewer to purchase a product within the video.

The flow 100 includes adding the product 140 within the short-form video to a virtual purchase cart based on the selecting. The virtual purchase cart can hold one or more items. In embodiments, the virtual purchase cart can include a virtual shopping cart. The virtual purchase cart can further include a virtual shopping bag, a virtual tote, etc. In embodiments, adding a product includes enabling a display interaction with a representation for the product. The product can be represented by an icon or other image. Such an icon can be made to appear to float over the short-form video or livestream. This icon, along with other icons from other added products, can be manipulated. Such manipulations can include shifting or stacking of the icons. In some embodiments, such manipulations can be purposeful to accomplish adding or extracting information. In other embodiments, the manipulations can be for gamification or entertainment purposes. In embodiments, the virtual purchase cart can include items that have been selected during an online session. The online session can include viewing a short-form video such as a livestream video or advertisement video. In embodiments, contents of the virtual purchase cart are visible while the short-form video is being viewed. Using this technique, the user can keep track of purchases already made during the viewing of the short-form video. In embodiments, the selecting not only adds the product to the virtual purchase cart, but the selecting actually completes the purchase provisionally, that is, purchasing steps are completed right up until the final processing of the purchase. The final processing of the purchase can occur after the short-form video reaches completion. In embodiments, the provisional purchase can be prevented, or “undone”, if a user selection is reverted before the short-form video reaches completion.

The flow 100 further includes enabling the virtual purchase cart using a security code 142 for validation. The code can include alphanumeric characters including numbers and letters, special characters, and so on. The code can be sent to a registered mobile phone number, a registered email address, and the like. The flow 100 further includes linking 144 the virtual purchase cart to an email address or a mobile phone number. The sending a code to the registered mobile phone number or registered email address not only enables stronger authentication such as two-factor authentication of a user, but the sending further confirms that the user has access to the registered mobile phone number and registered email address. In some embodiments, the sending of the code also validates that various information, such as payment details associated with that phone number or email address, payment details include customer name, shipping address, credit card details and associated payment card address (if different from shipping address), has been obtained. The flow 100 includes purchasing the product 146 which was selected. The purchasing the product which was selected can accomplish a “one-click” purchase technique. The purchasing the product which was added can be based on a user preregistering or logging in prior to viewing the short-form video. In the flow 100, the purchasing the product is accomplished while the short-form video is being viewed 148. The user can continue to view the video and can choose to select additional products for purchase.

The flow 100 includes displaying a representation 150 of the virtual purchase cart, wherein the representation is visible while viewing the short-form video. The representation can include an icon, a scrollable window, and so on. In embodiments, contents of the virtual purchase cart can be visible while the short-form video is being viewed. In the flow 100, the displaying of the representation of the virtual purchase cart can occupy a portion 152 of a display screen while the short-form video occupies another portion of the display screen. The user can continue to view the video, make additional selections of products, and so on. The portion occupied by the virtual purchase cart can include various sizes, shapes, locations, and the like. In embodiments, the representation of the virtual purchase cart can occupy substantially a third of the display screen. The sizes of other video objects displayed can be altered. In embodiments, the short-form video can be shrunk so that the whole video window is shown in the portion of the display screen showing the short-form video. The user can view the entire, albeit smaller, version of the video without obscuring the presenter, the products, etc. In other embodiments, a portion of the short-form video can be displayed, where the remaining portion of the short-form video can be covered by the virtual purchase cart. The technique can improve a user's viewing experience by rendering the video large enough to see. This technique can be particularly useful when implemented for mobile devices such as smartphones and tablets. In further embodiments, the virtual purchase cart can be partially transparent showing the short-form video portion being covered. This latter technique can also be effective when used with mobile devices.

The flow 100 includes checking out 160 from the virtual purchase cart. Checking out can include confirming that sufficient information associated with a product has been provided to proceed with a purchase. The information can include size, color, cut, quantity, and so on of a product. The checking out can further include that sufficient stock is available to fill an order for the product. The checking out can reserve stock for the order. In embodiments, the checking out from the virtual purchase cart can include purchasing the product, which was selected, wherein the purchasing the product can be accomplished while the short-form video is being viewed. The user can view the short-form video, purchase a desired product, and stop viewing the short-form video. Alternatively, the user can continue to watch the video. The short-form video can be an advertisement video provided by a third-party advertiser.

The flow 100 further includes purchasing contents 170 of the virtual purchase cart. The purchasing can include charging a user's credit card, providing product orders to a vendor, and so on. The flow 100 further includes finalizing purchase 172 of the product upon conclusion of a short-form video or livestream. In some embodiments, the finalizing occurs a certain period after conclusion of the short-form video or livestream, e.g., one minute, five minutes, 15 minutes, one hour, or some other duration. The finalizing purchase can be accomplished using a variety of techniques. In embodiments, the finalizing purchase is accomplished using a batch order process 174. Discussed throughout, the batch order process can combine orders of products purchased from a given vendor into as few as one order. Combining the orders of products can reduce vendor order processing, reduce numbers of packages shipped, conserve resources, etc. In embodiments, the batch order processing can occur upon conclusion of the short-form video. Since the viewing of a short-form video has ended and no more product purchases can be made, batch processing to finalize a purchase can proceed. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

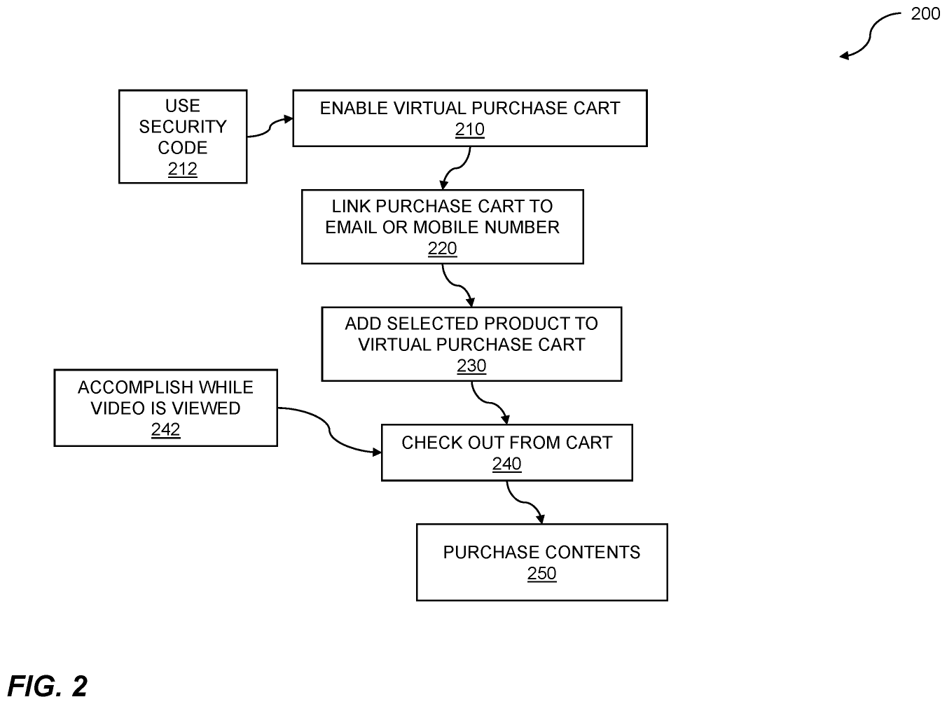

FIG. 2 is a flow diagram for virtual purchase cart handling. A video can be rendered on a user device using an application, an app, a web browser, and so on. Content can be provided to the application, app, web browser, etc. using a video interface. The video interface can render a video, display content, and so on. The video can include a livestream video, a video stream, a short-form video, and so on. The video can contain objects such as products that are being presented, discussed, offered for sale, and so on. The user to whom the video is rendered can interact with the video by selecting objects within the video. Selecting the objects can be used to purchase the objects, to fetch and provide information about the objects, etc. In embodiments, the selecting of an object can be accomplished by clicking, tapping, etc., a product or object within the video. The information that can be provided can be rendered on the user device. The information can include product information associated with selected products and objects within the video. A representation of a purchase cart into which selected objects can be placed for purchased can be displayed. The representation of the virtual purchase cart can be visible while the video such as a short-form video is being viewed. The virtual purchase cart can be handled in order to check out products selected by the user while the user views the video. The contents of the cart can be purchased using techniques such as a “one touch” technique that expedites the checkout and purchase tasks. The one touch can include the touch to select the product within the video. The virtual cart handling enables an ecommerce purchase within a short-form video environment. A short-form video from a plurality of short-form videos delivered from a short-form video server is rendered. A product within the short-form video is selected. The product within the short-form video is added to a virtual purchase cart based on the selecting. A representation of the virtual purchase cart, wherein the representation is visible while viewing the short-form video, is displayed. The virtual purchase cart is checked out.

The flow 200 includes enabling 210 a virtual purchase cart. The virtual purchase cart can be enabled by registering a user such as a new user, logging in a returning user, providing biometric authentication such as a fingerprint or facial recognition, and so on. The registering can include providing a username, an email address, a telephone number, etc. In the flow 200, the enabling is accomplished using a security code 212 for validation. The security code can include digits, letters, characters, and so on. The security code can be sent to an email address or phone number provided by the user. The flow 200 further includes linking the virtual purchase cart 220 to an email address or a mobile phone number. Recall that a phone number and email address were provided by the user when the user registered. Sending the security code to a phone number and an email address enables two-factor authentication and verifies that the email address and phone number provided the user are valid.

A user can select one or more products within a video they are viewing by interacting with the product. Interacting with the product can include tapping, clicking, hovering, and so on. The flow 200 includes adding 230 the product within the short-form video to a virtual purchase cart based on the selecting. Products that are selected for purchase during the viewing of the video can be purchased upon conclusion of the video. A representation of the virtual purchase cart can be displayed along with the video so that the user can keep track of what they have selected so far for purchase. The flow 200 includes checking out 240 from the cart. Checking out from the cart can include confirming that all information required for each purchase has been provided. The information can include payment information such as credit card number, expiration data, CCV number, card holder zip code, and so on. The information can further include contact information such as a mobile phone number, an email address, a physical address, and the like. The information can also include shipping information such as ground or expedited shipping, preferred carrier, preferred delivery location and dates, etc. The checking out can also include applying discounts such as quantity discounts or coupons, checking for other qualifications such as free shipping etc. In the flow 200, the checking out from the virtual purchase cart comprises purchasing the product 242 which was selected, wherein the purchasing the product is accomplished while the short-form video is being viewed. In this technique, the viewer can complete their purchase without having to watch the entire video.

The flow 200 further includes purchasing contents 250 of the virtual purchase cart. The purchasing the contents of the virtual purchase cart can include processing the order, charging the credit card, providing the order to the vendor of the products, and so on. Embodiments can include finalizing purchase of the product upon conclusion of the short-form video. In this latter technique, the user can purchase one or more products while viewing the video, then finalize the purchase of all items at once. In embodiments, the finalizing a purchase can be accomplished using a batch order process. The batch order process can combine products by vendor and can present the vendor with one combined order rather than indicating individual orders for each item. Providing one order to the vendor simplifies vendor order processing, combines items into one shipment, saves resources, and so on. The one order to the vendor can reduce shipping and handling charges for the customer (i.e., the viewer). Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

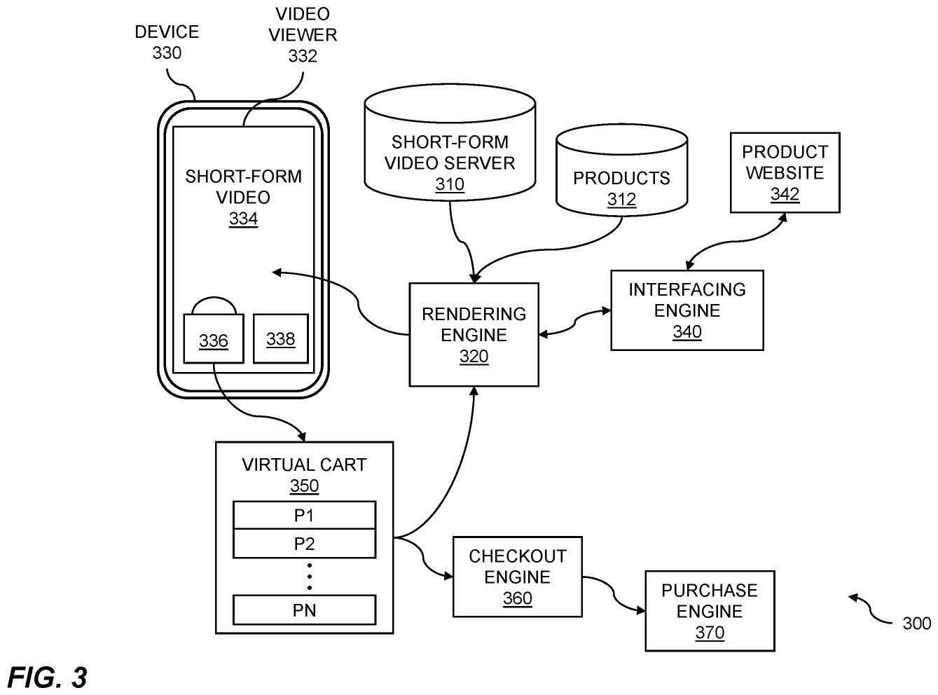

FIG. 3 shows a system block diagram for an ecommerce purchase within a video. An ecommerce purchase of a product within a video can be accomplished while the video is playing. The purchasing the product can be accomplished using a video stream interface. The video stream interface can support interaction between the user and the video stream. The interaction can include selecting objects such as one or more products that appear within the video stream. The interaction between the user and the video stream enables an ecommerce purchase within a short-form video environment. A short-form video from a plurality of short-form videos delivered from a short-form video server is rendered. The short-form video can include an advertisement. A product within the short-form video is selected. The product within the short-form video is added to a virtual purchase cart based on the selecting. A representation of the virtual purchase cart is displayed, wherein the representation is visible while viewing the short-form video. The video checkout experience can be accomplished on a merchant's e-commerce site or offsite, such as on a publisher's site. The short-form video, product selection, and purchase from a virtual purchase cart can be facilitated on such an e-commerce site, on a publisher's site, or other venue. The virtual purchase cart is used as part of the checkout process.

The system block diagram 300 can include a short-form video server 310. The short-form video server can include a local server, a remote server, a cloud server, a distributed server, and so on. The short-form video server can deliver a short-form video from a plurality of short-form videos. The short-form videos stored on the server can be uploaded by individuals, content providers, influencers, tastemakers, and the like. The system block diagram 300 can further include one or more lists of products 312. The lists of products can include products that can appear within one or more of the short-form videos. The one or more products that appear within a given short-form video can be available for sale. A user viewing a short-form video can purchase the one or more products by interacting with the products within the short-form video. The system block diagram can include a rendering engine 320. The rendering engine can render a short-form video and one or more products for display. The short-form video that is rendered can be rendered on a display associated with a device 330. The rendering the short-form video can be accomplished using a video viewer 332. The video viewer can include a video app, a web browser, and so on. The short-form video 334 can be displayed on a portion of the display associated with the device. Other portions of the device can be occupied by a representation of a virtual purchase cart 336, product information 338 (discussed below), etc.

A user can obtain further information associated with a product in which the user is interested. The system block diagram 300 can include an interfacing engine 340. The interfacing engine can be used to access the further product information and to provide that information for rendering by the rendering engine. The interfacing engine can obtain information from a product website 342. Embodiments include obtaining information on the product from a website hosted by a third party. The third party can include an online retailer, a service provider, an influencer, a tastemaker, a celebrity, and the like. Product information obtained from the third-party website can be rendered and displayed. The display of the product information can occupy a portion of the display screen associated with the device. In embodiments, the product information occupies substantially a third of the display screen.

The user can interact with the video user interface. The interacting can include common actions, gestures, and so on, utilized by a user as they interact with a device such as a personal electronic device. In embodiments, the user interaction can be accomplished by mousing over an object in the video. The mousing can in turn be accomplished by moving a cursor with a mouse device, sliding a digit over a trackpad, and the like. In other embodiments, the user interaction can be accomplished by clicking on an object in the video. The clicking can include clicking a button on a mouse device, tapping a trackpad, etc. In further embodiments, the interfacing can include a request for further information on an object, based on the user interaction. An object can include a product or service, an item used by a person present in the website content, an item presented by the person, and the like. Interaction by the user with a product within the video can cause the product to be selected and added to a virtual cart. The system block diagram can include a virtual purchase cart 350. The virtual purchase cart, which can include a virtual shopping cart, a virtual shopping bag, a virtual tote, etc., can include one or more products selected for purchase by the user. The products can include product P1, product P2, and so on, up to product PN. In embodiments a representation of the virtual purchase cart can be displayed on the device. The representation is visible while viewing the short-form video. Information associated with the virtual purchase cart and its contents can be provided to the rendering engine for display on the device.

The virtual purchase cart can be checked out. The system block diagram can include a checkout engine 360. The checking out can include verifying that the items selected by the user while viewing the short-form video are in stock; that information such as size, color, or configuration has been provided; etc. When sufficient product information has been collected, final purchase of the products can be accomplished. The system block diagram can include a purchase engine 370. The purchase engine can collect information required to finalize the one or more purchases. The information can include payment information such as credit card number and expiration date; contact information such as mailing address, email address, and phone number; shipping preferences; etc. The information collected by the purchase engine can be securely stored by a payment service provider if the purchaser so choses. For example, if the purchaser previously completed a transaction within the system 300 that displays short-form videos, livestreams, advertisements, etc., and elected to have their payment information securely stored by the payment provider, then their payment information can be pre-populated when making a purchase in another system using a different video server. The pre-population can be predicated on correctly completing a two-factor authentication (2FA), using a code sent to their mobile phone, for example. Embodiments further can include finalizing purchase of the product upon conclusion of the short-form video. By the end of the short-form video, the user can select all the products they want to purchase, so the purchase can be finalized. In embodiments, the finalizing purchase can be accomplished using a batch order process. The batch order processing can enable all items purchased from a given vendor to be placed on the same order rather than creating a separate order for each item.

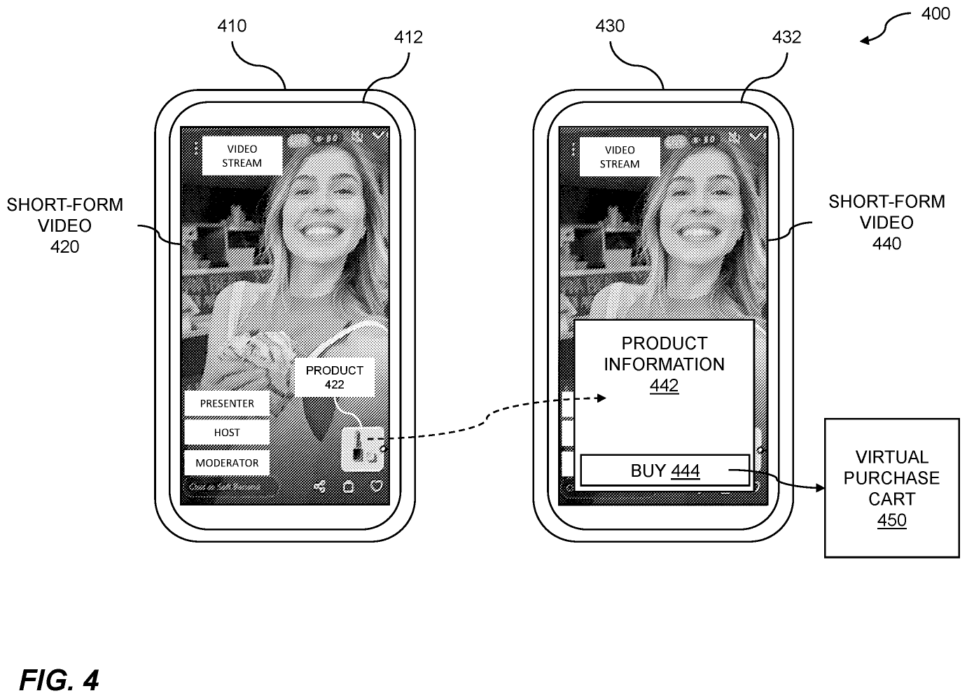

FIG. 4 illustrates adding an item to a virtual purchase cart. A user can view a video stream in which one or more of a variety of products can be displayed. The products can be promoted, endorsed, explained, demonstrated, etc. by one or more people within the video stream. The video stream can include a short-form video, a livestream video, and so on. By interacting with a video user interface, the user can indicate a product of interest and can purchase the item, be presented with information associated with the product of interest, etc. The interacting with the video enables the user to select one or more products within the video. The interacting with the user interface can be based on familiar interactions such as moving a cursor, hovering a cursor, tapping, clicking, and so on. The user can select products within the video for purchase by selecting the items. Additional information about one or more products in which the viewer is interested can be provided. The information can be scrubbed from a website hosted by a third party. Adding an item to a virtual purchase cart enables an ecommerce purchase within a short-form video environment. A short-form video from a plurality of short-form videos delivered from a short-form video server is rendered. A product within the short-form video is selected. The product within the short-form video is added to a virtual purchase cart based on the selecting. A representation of the virtual purchase cart is displayed, wherein the representation is visible while viewing the short-form video. The virtual purchase cart is checked out.

An example illustrating adding an item to a virtual purchase cart is shown 400. The video stream can be rendered on a device 410. The device can include a handheld device such as a smartphone, PDA, or tablet: a portable device such as a laptop computer; a desktop computer; and so on. The device can include a display 412 on which an app such as a video player, web browser, and so on, can render content. The content can include a video stream delivered from a server. In embodiments, the video stream can include a short-form video 420, and the server can include a short-form video server. The video can include a livestream video, a video stream, a short-form video, and so on. The video can include a product presentation, a tastemaker or influencer talking about their favorite product, and so on. The rendering of the video stream can include other boxes, fields, labels, etc. In embodiments, the fields can include a presenter, a host, a moderator, a chat window, a comments window, and the like. The video stream can include one or more products such as product 422. The product can be described, promoted, demonstrated, etc., by the one or more people within the video. The person viewing the video can select the product for purchase.

Selecting a product within the video can cause product information associated with the product to be displayed. The displaying of the product information can be accomplished on a display 432 associated with a device 430. The short-form video 440 can continue to play while the product information is displayed. The product information can be obtained by or “scrubbed” from accessing website content from a website hosted by a third party. The product information 442 can be displayed on the device using a video player. Product information can include video about the product which the viewer wishes to purchase. In a usage example, an influencer can be discussing her or his favorite product such as a smartphone case. While they are doing that, the item video can present information about the smartphone case. The information can include different sizes for different smartphone models, color selections available, additional features such as card carriers or charging interfaces, and the like. A user viewing the product presentation can swipe, tap, click, or otherwise interact with the item to indicate that the user wishes to purchase the item and that further information about the item within the video is desired. The item that the user wishes to purchase can be added to a virtual purchase cart by selecting the item. The item can be selected by interacting with the item within the video, clicking a “Buy” or similar button 444 associated with the product information, and so on. Selecting the item can add the item to a virtual purchase cart 450. A representation of the virtual purchase cart can be displayed on the device while the video continues to play. In embodiments, the displaying of the representation of the virtual purchase cart can occupy a portion of a display screen while the short-form video can occupy another portion of the display screen. The representation of the virtual purchase cart can occupy varying sized portions of the display screen. In embodiments, of the virtual purchase cart can occupy substantially a third of the display screen. The size of the short-form video can be adjusted in order to support continued viewing of the video. In embodiments, the short-form video is shrunk so that the whole video window is shown in the portion of the display screen showing the short-form video. Other display techniques can be used to show the representation of the virtual purchase cart. The short-form video can be partially covered by the representation of the cart (as shown), the cart can be partially transparent, etc.

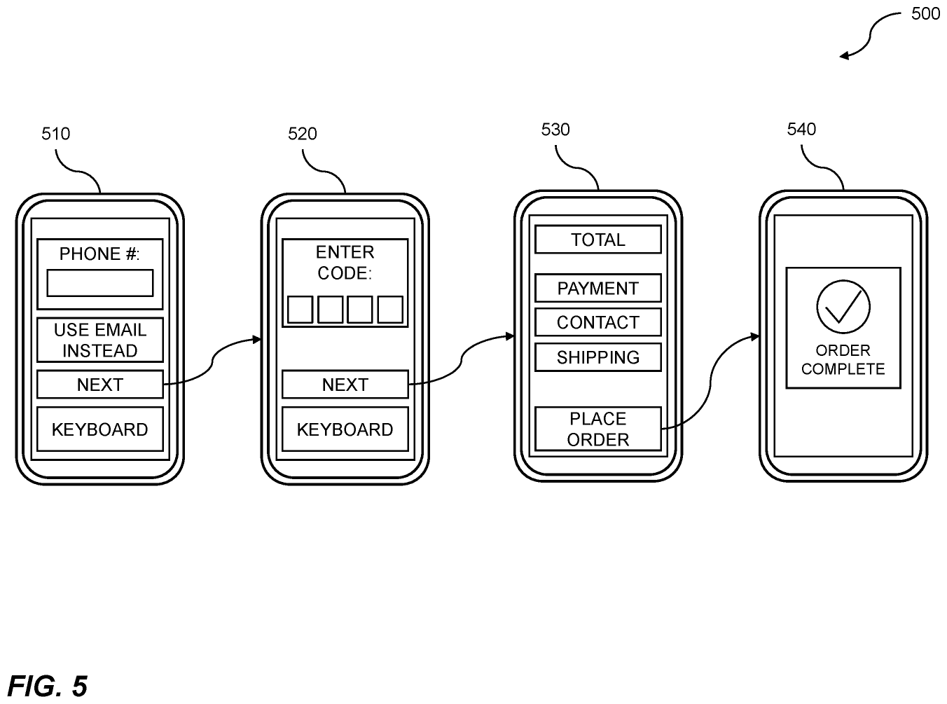

FIG. 5 shows enabling a virtual purchase cart for purchase. Discussed above and throughout, a person viewing a video such as a short-form video can select one or more products included within the video. The selecting, which can be accomplished by tapping, clicking, swiping, mousing over, etc., adds the desired product to a virtual purchase cart. Products added to the virtual purchase cart can be purchased. If the user has “preregistered” prior to viewing the video, then the virtual purchase cart associated with the viewer is enabled. Enabling the virtual purchase cart by preregistration in turn enables the viewer to check out items within their virtual purchase cart using a “one-click” technique. Enabling the viewer's virtual purchase cart enables an ecommerce purchase within a short-form video environment. A short-form video from a plurality of short-form videos delivered from a short-form video server is rendered. A product within the short-form video is selected. The product within the short-form video is added to a virtual purchase cart based on the selecting. A representation of the virtual purchase cart is displayed, wherein the representation is visible while viewing the short-form video. The virtual purchase cart is checked out. Contents of the virtual purchase cart are purchased. Purchase of the product is finalized upon conclusion of the short-form video.

Enabling a virtual purchase cart for purchase of products within a short-form video is shown 500. The virtual purchase cart can be enabled by registering a new user, logging in a returning user or user who has previously registered, and so on. The enabling the virtual purchase cart can be accomplished using a web browser, an app, etc. The web browser or the app can be executed on a device such as a mobile device, computer, and the like. The preregistration or login can be accomplished while the user is waiting for a video stream, such as a livestream, short-form video, etc., to start. Registration or login can further be accomplished during viewing of the video. The registration or login can be initiated on a user device by providing a phone number or email address 510, where the phone number or email address is associated with the user. A keyboard or microphone can be enabled to allow the user to enter digits, letters, characters, and the like. The user can tap a button such as a “next” button to proceed to a next screen. The user can be asked to enter a code 520. The code can include an alphanumeric code. The code can be sent to the phone number or email address entered on the previous screen. Sending the code can be used to verify that the user has access to the provided phone number and/or email address. The user can enter the code and tap next to proceed to a next screen.

The next screen can present the user with a summary of her or his purchases 530. The screen can further provide payment, contact, and shipping information. If the user has previously entered information associated with payment, contact, and shipping, then the fields can be prepopulated with previously provided information. If the user has not previously entered the required information, they can do so here. Having verified purchase totals and entered any required information, the user can place their order. An “Order Complete”, “Thanks for Purchasing”, or similar message can be displayed 540. In embodiments, the finalizing purchase of the product or products within the virtual purchase cart associated with the user is performed upon conclusion of the short-form video, livestream video, and so on. In embodiments, the finalizing purchase can be accomplished using a batch order process. Discussed previously, the batch processing can consolidate products by vendor, apply quantity discounts, apply coupon codes, determine shipping rates, and the like. The consolidating products into as few orders as possible can reduce shipping costs, resource utilization, etc.

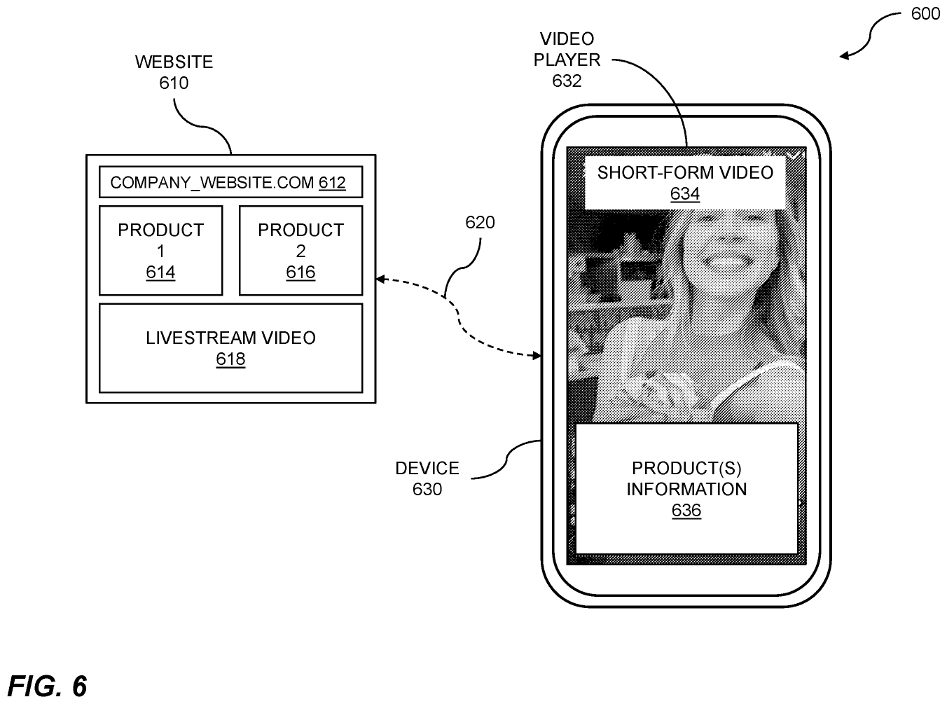

FIG. 6 illustrates a short-form video and product information on a device. A user can view a video, where the video can include a livestream video, a video stream, a short-form video, and so on. The video can include products, services, and the like, which can be promoted by a provider of the videos. The livestream videos and other videos, which can include videos presented by celebrities, tastemakers, influencers, and so on, can mention, promote, endorse, highlight, or otherwise present one or more products. The products can be available for purchase within the video. A user can learn more about the products, purchase the products, etc., by clicking on the products within a video. The video and product information associated with products within the video can be rendered on a device such as a personal electronic device. The rendering of the video and the product information enables ecommerce purchase within a short-form video environment. A short-form video from a plurality of short-form videos delivered from a short-form video server is rendered. A product within the short-form video is selected. The product within the short-form video is added to a virtual purchase cart based on the selecting. A representation of the virtual purchase cart is displayed, wherein the representation is visible while viewing the short-form video. The virtual purchase cart is checked out.

Short-form video and product information rendered on a device are illustrated 600. Information on the product is obtained from a website 610 hosted by a third party. The website can comprise one or more webpages which can include text, one or more videos, one or more audio files, and so on. The website is accessible by providing a universal resource locator (URL) address 612. To access the website, a URL associated a product can be automatically entered into a web browser such as Chrome™, Edge™, Firefox™, Opera™, Safari™, etc. The contents of the webpage can include information associated with one or more products such as product 1 614, product 2 616, and so on. While two products are shown, other numbers of products can be included on the webpage, webpages accessible through the webpage, etc. The contents of the webpage can further include livestream video 618. The livestream video can show a 360-degree view of the product, can instruct users in the use of the products, and so on.

The contents of the one or more webpages associated with the website 610 can be provided to a device 630 via a connection 620 such as a network connection. The connection 620 can include a wireless connection such as a Wi-Fi™, Bluetooth™, or cellular connection; a wired connection such as an Ethernet™ connection; and so on. An app such as a video player app 632 can be executed on the device in order to display a short-form video 634. The short-form video, which can include a livestream video, can include one or more products described on the website 610. In embodiments, the website contents including product information 636 can be rendered for a user by a video user interface. The video user interface can be used to display the short-form video, the product information, etc. The information associated with the one or more products can be obtained from the website 610. The one or more products within the video stream video can be selectable by the user in order to obtain further information about the one or more products, to purchase the products, and so on. The products can be selected for purchase by clicking on a product, mousing over a product for a specified duration, and so on. Icons associated with the website can also be rendered by the video player. The icons can include one or more icons such as online vending, social media, and so on. In embodiments, the icons can include a chat box, a sharing icon, a shop icon such as a bag or cart, a “like” icon, etc. The icons can be used to purchase one or more products, discuss the products, provide links to other or similar products, and so on.

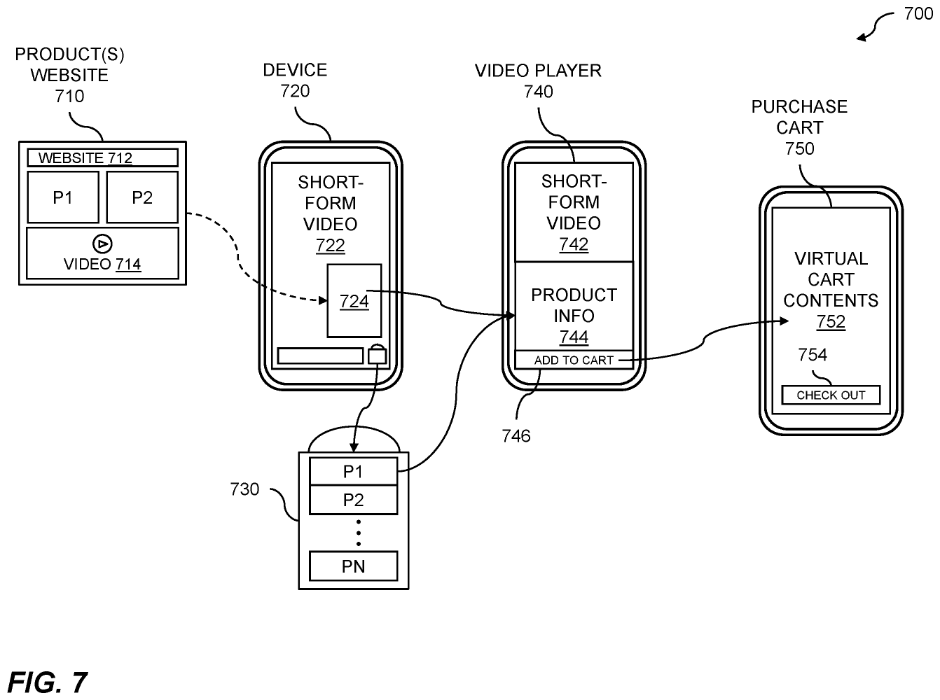

FIG. 7 is a system block diagram for an add-to-cart operation 700. A user can view a video in which a product is introduced, promoted, endorsed, and so on. The user can choose to learn more about the product and if interested, can add the product to a shopping bag or cart in order to purchase the product. The user can learn about the product, can purchase the product, etc., without leaving the video that contains the product. Instead, the video can continue to play while the user is learning more about the product, purchasing the product, etc. The add-to-cart operation can be accomplished by clicking on an icon representing a virtual purchase cart or by interacting with the product within the video. The interacting can include tapping, clicking, swiping, mousing over or hovering, and the like. The add-to-cart operation enables an ecommerce purchase within a short-form video environment. A short-form video from a plurality of short-form videos delivered from a short-form video server is rendered. A product within the short-form video is selected. The product within the short-form video is added to a virtual purchase cart based on the selecting. A representation of the virtual purchase cart is displayed, wherein the representation is visible while viewing the short-form video. The virtual purchase cart is checked out.

A website 710 can include information associated with one or more products, where the products can be included within a short-form video, livestream video, and so on. The website can be accessible using a uniform resource locator (URL) or “web address” 712. The URL can be automatically input to a web browser to access the website. The website can include text, videos, audio files, and other content. The website can include product information associated with one or more products such as product P1 and product P2. The website can include video content such as video 714 associated with a product. The video can include livestream video, a video stream, a short-form video, and the like. A device 720 can be used to display a short-form video 722. The device can include a hand-held electronic device, a portable electronic device, a desktop electronic device, and so on. In addition to the short-form video, product information 724 can be rendered. The product information can include text, photos, videos, etc. The user who is viewing the short-form video and the product information can choose to learn more about one or more products. The user can learn more about the products by interacting with a shop icon such as a bag or cart icon, by tapping on a product presented in the video 722, etc. Interacting with the product can add the product to a virtual purchase cart 730. The virtual purchase cart can include a virtual shopping cart, a virtual shopping bag, a virtual tote, and so on. The virtual purchase cart can include one or more products such as product P1, product P2, product PN and so on. The user can select a product such as product P1 to obtain information associated with the product.

A video player 740 can be used to render the short-form video 742. The video player can further render information 744 for a product selected within the short-form video or added to the virtual purchase cart 730. The product information can present details associated with the product such as size, color, price, availability, shipping and other costs, configuration information, and so on. A user can choose to select the product for purchase by interacting with the product in the short-form video and clicking a shop icon such as an “Add to Cart” icon 746. Interaction by the user with the virtual purchase cart icon enables display of a purchase cart 750 on the device 720 with which the user is interacting. Virtual purchase cart contents 752 can include one or more products that the user selected for purchase while viewing the short-form video. When the user is ready purchase, the user can indicate this by tapping, clicking, etc. on an icon such as a “Check Out” icon 754. The checking out can be performed automatically. Embodiments include finalizing purchase of the product or products within the virtual purchase cart upon conclusion of the short-form video. In embodiments, the finalizing purchase can be accomplished using a batch order process. The batch processing can “combine” the product orders in order to take advantage of quantity discounts, discount codes, shipping discounts, and the like. In embodiments, the batch order processing can occur upon conclusion of the short-form video.

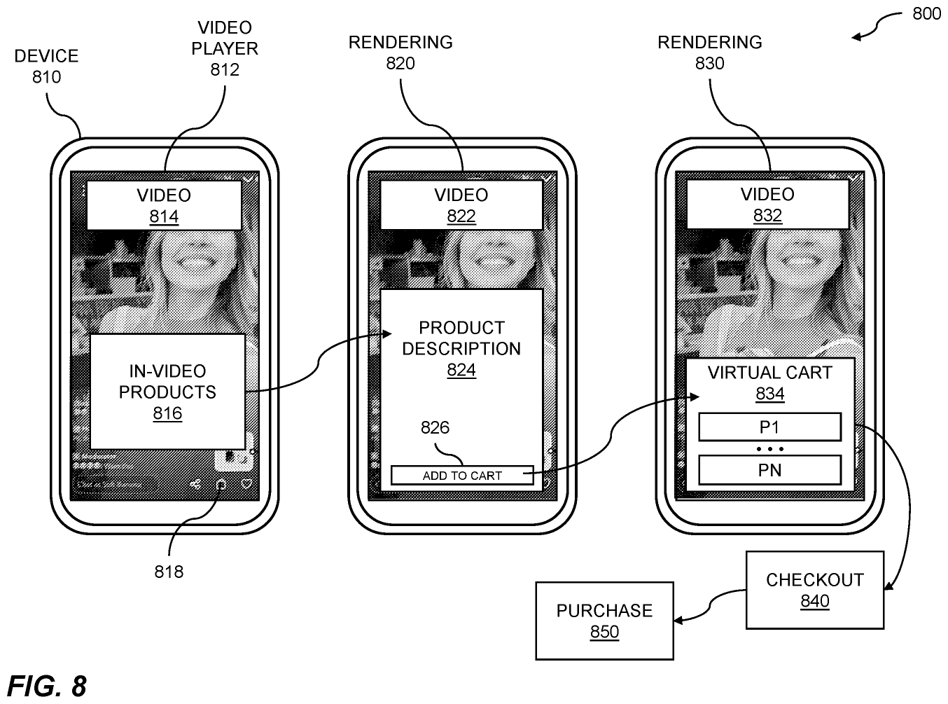

FIG. 8 illustrates product purchase within a short-form video. A user can be viewing a video such as a short-form video, where the video can include a livestream video, a video stream, a prerecorded video, and so on. The user may be interested in a product presented within the video and may wish to purchase the product. By clicking on, tapping on, or mousing over the product within the video, the user can purchase the product. Selecting the product within the video presents the user with information associated with the product of interest. The information on the product is obtained from a website hosted by a third party. The product information can be displayed along with the video, where the product information and the video can be rendered for the user using a video user interface associated with a device such as a mobile device. The short-form video and the information enhance a product ecommerce purchase experience. A short-form video from a plurality of short-form videos delivered from a short-form video server is rendered. A product within the short-form video is selected. The product within the short-form video is added to a virtual purchase cart based on the selecting. A representation of the virtual purchase cart is displayed, wherein the representation is visible while viewing the short-form video. The virtual purchase cart is checked out.

Product purchase within a short-form video is illustrated 800. A device 810 associated with a user can provide a video and in-video products to the user using a video player 812. The device can include a personal electronic device, a computer, and so on. The video player can include a video stream player or other video player. Video content 814 such as short-form video content delivered from a short-form video server can be rendered for a user associated with the device. The video content can include the short-form video, products, links such as hyperlinks to in-video products 816, a virtual purchase cart representation 818 such as a shopping cart, shopping bag, or tote, and the like. The website content can include text, video, audio, etc. An item video, linked from in-video products 816, can also be presented to the user. The item video can include video associated with a product that can be included within the website content. In addition to the website content, a “shop” icon, such as virtual purchase cart representation 818, can be included. The shop icon can be represented by a bag, a cart, and so on. A user who wanted to learn more about a product seen in the website content can click, tap, or otherwise interact with the shop icon.

Clicking on the in-video product can take the user to a rendering 820. The rendering 820 can include the video 822, where the video, such as a short-form video, can continue to play. The rendering can further include a product description 824 associated with the in-video product that was clicked. The product associated with the product description can be selected by clicking on an “Add to Cart” 826 or similar button, clicking on the product, hovering a cursor over the product for a specified duration, etc. Selecting the product can present a further rendering 830 to the user. The further rendering can include the video 832, which can continue to play. The rendering can further include contents 834 of a virtual purchase cart. The contents can include one or more products such as products P1 to PN. In embodiments, contents of the virtual purchase cart are visible while the short-form video is being viewed. In embodiments, the virtual purchase cart can occupy substantially a third of the display screen. In other embodiments, the virtual purchase cart can occupy one quarter, one half, or another portion of the display screen. Checking out from the virtual purchase cart can be accomplished with a checkout component 840. In embodiments, the checking out from the virtual purchase cart can include purchasing the product 850 which was selected by the selecting, wherein the purchasing the product is accomplished while the short-form video is being viewed. Recall that more than one product can be purchased by the user selecting multiple products while the short-form video is playing. Further embodiments include finalizing purchase of the product upon conclusion of the short-form video. Finalizing purchase can be accomplished for more than one product. In embodiments, finalizing purchase is accomplished using a batch order process. The batch process can compute quantity discounts, apply coupons, check for free shipping, etc. In embodiments, the batch order processing occurs upon conclusion of the short-form video.

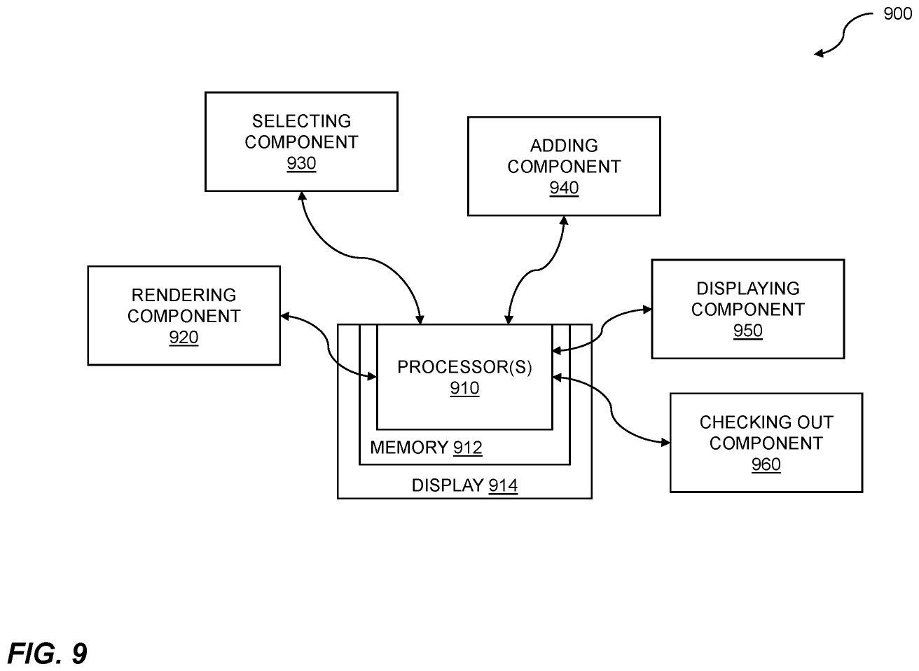

FIG. 9 is a system diagram for ordering items. Ordering items is enabled by an ecommerce purchase within a short-form video. The short-form video can include a prerecorded video, a livestream video, and so on. The system 900 can include one or more processors 910 attached to a memory 912 which stores instructions. The system 900 can include a display 914 coupled to the one or more processors 910 for displaying data, video streams, videos, product information, virtual purchase cart contents, webpages, intermediate steps, instructions, and so on. In embodiments, one or more processors 910 are attached to the memory 912 where the one or more processors, when executing the instructions which are stored, are configured to: render a short-form video from a plurality of short-form videos delivered from a short-form video server; select a product within the short-form video; add the product within the short-form video to a virtual purchase cart based on the selection; display a representation of the virtual purchase cart wherein the representation is visible while viewing the short-form video; and check out from the virtual purchase cart.

The system 900 can include a rendering component 920. The rendering component 920 can include functions and instructions for rendering a short-form video from a plurality of short-form videos delivered from a short-form video server. The rendering can be accomplished using a user interface such as a web browser, a video player app, a specialty app provided by a vendor or service, etc. The rendering of the short-form video can be accomplished on a variety of electronic devices. In embodiments, the rendering can be accomplished on a mobile device, a computer such as a laptop computer or desktop computer, and so on. The short-form video that is rendered by the user interface can include a variety of video types. In embodiments, the short-form video can include a livestream video. The livestream video can be presented by an enterprise, a celebrity, a promoter, etc. A live video stream can be created by and originate from variety of individuals who can include a tastemaker, an influencer, an artist, a musician, a DJ, an individual with content she or he wants to share, a provider of a good or service, and so on. The video stream can include content such as one or more products. The products can include items that the creator uses, recommends, promotes, endorses, and so on. The products can include various goods. In embodiments, the product can include a service. In other embodiments, the product can include a coupon or a membership. The short-form video can include a curated stream, videos from a streaming website, a video server, social media or other shared sites, and the like. The video stream can include a recorded message, a livestream, a previously recorded livestream, etc. A short-form video can include a video that displays for 30 seconds, 2.5 minutes, fewer than 10 minutes, and the like. In embodiments, the rendering the short-form video and products within the video is accomplished without a popup window.

The system 900 can include a selecting component 930. The selecting component 930 can include functions and instructions for selecting a product within the short-form video. In a usage example, a viewer can be experiencing a short-form video provided by a tastemaker. Within the short-form video, a variety of products can be seen. The products can include cosmetics, kitchen wares, power tools, etc. The viewer can decide to select an item for purchase. In embodiments, the selecting of the product can be accomplished by clicking on an object in the video. The viewer of the short-form video can move a cursor using a mouse, trackpad, etc., to a product and can perform a “click” operation. In other embodiments, the selecting of the product can be accomplished by mousing over an object in the short-form video for a specified duration. The mousing over a selection can be accomplished by moving a cursor over a product and hovering the cursor there for a specified duration such as a few seconds. The system 900 can include an adding component 940. The adding component 940 can include functions and instructions for adding the product within the short-form video to a virtual purchase cart based on the selecting. More than one item within the short-form video can be added to the virtual purchase cart based on additional selections. In embodiments, the virtual purchase cart can include a virtual shopping cart, a virtual shopping bag, a virtual tote, and so on.

The system 900 can include a displaying component 950. The displaying component 950 can include functions and instructions for displaying a representation of the virtual purchase cart wherein the representation is visible while viewing the short-form video. The virtual purchase cart can appear over the short-form video that is being rendered. The virtual purchase cart can include one or more representations of one or more products that have been selected by the user. The virtual purchase cart can be displayed in a window, a popup window, a frame, and the like. In embodiments, the displaying of the representation of the virtual purchase cart can occupy a portion of a display screen while the short-form video occupies another portion of the display screen. The portion of the display screen can include a corner, a region, and so on. In embodiments, the representation of the virtual purchase cart can occupy substantially a third of the display screen. Other portions of the display can also be occupied. In other embodiments, short-form videos can be shrunk so that the whole video window is shown in the portion of the display screen showing the short-form video. Shrinking the short-form video enables viewing of the video without a portion of the video being obscured by the virtual purchase cart. In other embodiments, a portion of the short-form video can be displayed where the remaining portion of the short-form video is covered by the virtual purchase cart. The rendering and displaying the full video or partially obscured video can be controlled by a presenter setting, a viewer setting, etc. Other techniques can be used to display the short-form video and the virtual purchase cart. In further embodiments, the virtual purchase cart can be partially transparent showing the short-form video portion being covered. The user may choose to learn more about a product. Embodiments include obtaining information on the product from a website hosted by a third party. The information can include sizes, colors, product details, and the like. Embodiments can further include displaying the information on the product while the short-form video is being viewed and the virtual purchase cart is visible. The short-form video can be augmented with the information on the product. The augmenting can include displaying the further information, featuring the further information, and so on.

The system 900 can include a checking out component 960. The checking out component 960 can include functions and instructions for checking out from the virtual purchase cart. The checking out can be accomplished using a variety of techniques. The checking out can include checking out one or more items that were added to the virtual purchase cart. The checking out from the virtual purchase cart can include purchasing the product, which was selected, wherein the purchasing the product is accomplished while the short-form video is being viewed. In embodiments, the adding the product within the short-form video to the virtual purchase cart can result in a purchase of the product at the time of the adding. The purchasing can include “one-click checkout”. In a usage example, a new user can complete a pre-livestream registration operation. The pre-livestream registration can include accomplishing a login using an email address or phone number associated with the user. A returning user can log in using an email address or phone number that was previously registered. The user can receive a verification code via email or text message. The code is entered to register the user. When a product is added to the virtual purchase cart, the user can review her or his order and place the order. In embodiments, batch order processing can occur upon conclusion of the short-form video (e.g., after the viewer has made all of her or his purchase decisions).

Recall that the virtual purchase cart can include one or more products that were selected by a viewer of a short-form video during the short-form video. In embodiments, the virtual purchase cart can include items that have been selected during an online session. The checking out can include purchase of all of the items in the virtual purchase cart. Embodiments can include finalizing purchase of the product upon conclusion of the short-form video. Finalizing purchase of one or more products upon conclusion of the short-form video can enable ordering and fulfillment efficiencies for the buyer and the vendor. In embodiments, the finalizing purchase can be accomplished using a batch order process. The batch order process can enable discounts based on a purchase amount, free shipping, and other benefits associated with larger more valuable purchases.

The system 900 can include a computer program product embodied in a non-transitory computer readable medium for ordering items, the computer program product comprising code which causes one or more processors to perform operations of: rendering a short-form video from a plurality of short-form videos delivered from a short-form video server; selecting a product within the short-form video; adding the product within the short-form video to a virtual purchase cart based on the selecting; displaying a representation of the virtual purchase cart wherein the representation is visible while viewing the short-form video; and checking out from the virtual purchase cart.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for ordering items comprising:
rendering a short-form video from a plurality of short-form videos delivered from a short-form video server;
selecting a product within the short-form video;
adding the product within the short-form video to a virtual purchase cart based on the selecting;
displaying a representation of the virtual purchase cart wherein the representation is visible while viewing the short-form video; and
checking out from the virtual purchase cart.

2. The method of claim 1 wherein contents of the virtual purchase cart are visible while the short-form video is being viewed.

3. The method of claim 1 wherein the virtual purchase cart comprises a virtual shopping cart.

4. The method of claim 1 wherein the virtual purchase cart includes items that have been selected during an online session.

5. The method of claim 1 further comprising purchasing contents of the virtual purchase cart.

6. The method of claim 5 further comprising finalizing purchase of the product upon conclusion of the short-form video.

7. The method of claim 6 wherein the finalizing purchase is accomplished using a batch order process.

8. The method of claim 7 wherein the batch order processing occurs upon conclusion of the short-form video.

9. The method of claim 1 wherein the checking out from the virtual purchase cart comprises purchasing the product, which was selected, wherein the purchasing the product is accomplished while the short-form video is being viewed.

10. The method of claim 1 wherein the displaying of the representation of the virtual purchase cart occupies a portion of a display screen while the short-form video occupies another portion of the display screen.

11. The method of claim 10 wherein the representation of the virtual purchase cart occupies substantially a third of the display screen.

12. The method of claim 10 wherein the short-form video is shrunk so that the whole video window is shown in the portion of the display screen showing the short-form video.

13. The method of claim 10 wherein a portion of the short-form video is displayed where the remaining portion of the short-form video is covered by the virtual purchase cart.

14. The method of claim 13 wherein the virtual purchase cart is partially transparent showing the short-form video portion being covered.

15. The method of claim 1 wherein the selecting of the product is accomplished by clicking on an object in the video.

16. The method of claim 1 wherein the selecting of the product is accomplished by mousing over an object in the short-form video for a specified duration.

17. The method of claim 1 wherein the short-form video is recommended based on a user journey.

18. The method of claim 17 wherein the user journey comprises videos watched, internet interactions, or purchase history.

19. The method of claim 1 further comprising enabling the virtual purchase cart using a security code for validation.

20. The method of claim 1 wherein the short-form video comprises a livestream video.

21. The method of claim 1 wherein the short-form video comprises an advertisement video.

22. The method of claim 1 wherein the rendering and the displaying are accomplished on a mobile device.

23. The method of claim 1 further comprising obtaining information on the product from a website hosted by a third party.

24. The method of claim 23 further comprising displaying the information on the product while the short-form video is being viewed and the virtual purchase cart is visible.

25. The method of claim 23 further comprising augmenting the short-form video with the information on the product.

26. The method of claim 1 wherein the product comprises a coupon, a membership, or a service.

27. The method of claim 1 further comprising linking the virtual purchase cart to an email address or a mobile phone number.

28. A computer program product embodied in a non-transitory computer readable medium for ordering items, the computer program product comprising code which causes one or more processors to perform operations of:
rendering a short-form video from a plurality of short-form videos delivered from a short-form video server;
selecting a product within the short-form video;
adding the product within the short-form video to a virtual purchase cart based on the selecting;
displaying a representation of the virtual purchase cart wherein the representation is visible while viewing the short-form video; and
checking out from the virtual purchase cart.

29. A computer system for ordering items comprising:
a memory which stores instructions;
one or more processors attached to the memory wherein the one or more processors, when executing the instructions which are stored, are configured to:
render a short-form video from a plurality of short-form videos delivered from a short-form video server;
select a product within the short-form video;
add the product within the short-form video to a virtual purchase cart based on the selection;
display a representation of the virtual purchase cart wherein the representation is visible while viewing the short-form video; and
check out from the virtual purchase cart.
